(19) United States
(12) Patent Application Publication
(10) Pub. No.: US 2011/0082954 A1
(43) Pub. Date: Apr. 7, 2011

(54) HOST APPARATUS, EXTERNAL STORAGE APPARATUS AND METHOD FOR MAINTAINING SHARING SETTING THEREOF

(75) Inventor: Kyung-hoon KIM, Seongnam-si (KR)

(73) Assignee: SAMSUNG ELECTRONICS CO., LTD., Suwon-si (KR)

(21) Appl. No.: 12/762,395

(22) Filed: Apr. 19, 2010

(30) Foreign Application Priority Data
Oct. 7, 2009 (KR) 10-2009-0095097

(51) Int. Cl. G06F 13/12; G06F 12/00; G06F 12/02

(52) U.S. Cl. 710/74; 711/170; 711/154; 711/E12.002

(57) ABSTRACT

A host apparatus, an external storage apparatus, and a method for maintaining a sharing setting thereof, are provided, the host apparatus including: an interface which communicates with an external storage apparatus; a storage unit; an information generator which generates sharing setting information regarding a content stored in the external storage apparatus, if a command to establish a sharing setting for the content stored in the external storage apparatus is input; and a controller which controls the generated sharing setting information to be stored in the storage unit and/or the external storage apparatus and controls a sharing setting state to be maintained if the external storage apparatus is disconnected. Accordingly, the sharing setting state can be maintained even if the external storage apparatus is disconnected.

### CROSS-REFERENCE TO RELATED APPLICATION

This application claims priority from Korean Patent Application No. 10-2009-0095097, filed on Oct. 7, 2009 in the Korean Intellectual Property Office, the disclosure of which is incorporated herein by reference in its entirety.

### BACKGROUND

1. Field

Aspects of the present inventive concept relate to a host apparatus, an external storage apparatus, and a method for maintaining a sharing setting thereof, and more particularly, to a host apparatus and an external storage apparatus which store sharing setting information regarding the external storage apparatus to maintain a sharing setting, and a method for maintaining a sharing setting thereof.

2. Description of the Related Art

An external storage apparatus may use a universal serial bus (USB) port for connectivity, and a product in which an external storage apparatus is embedded may also support the USB port. The external storage apparatus is recognized as a drive or a directory according to an operating system (OS) of a device in which a USB host is located, and is registered as a driver or a directory.

Users who have access to a network can share contents which are stored in the external storage apparatus through a sharing setting established for each OS. However, when the external storage apparatus is connected, the external storage apparatus is not always recognized as the same drive or directory due to a property of USB operation, whereby the OS assigns an arbitrary value to the external storage apparatus. Therefore, since the external storage apparatus is not recognized as a drive or directory which has been previously set for sharing by the OS, a previous sharing setting state is canceled. Some operating systems cancel a sharing setting whenever the external storage apparatus is disconnected.

Therefore, if a user wishes to reuse an external storage apparatus which has been previously recognized by a host and stores content to be shared, the user is required to re-establish a sharing setting because a previous sharing setting is canceled. This causes inconvenience to users.

### SUMMARY

Exemplary embodiments overcome the above disadvantages and other disadvantages not described above. However, it is understood that an exemplary embodiment of the present inventive concept is not required to overcome the disadvantages described above, and an exemplary embodiment may not overcome any of the problems described above.

Exemplary embodiments provide a host apparatus and an external storage apparatus which maintain a sharing setting of the external storage apparatus, and a method for maintaining a sharing setting thereof.

According to an aspect of an exemplary embodiment, there is provided a host apparatus including: an interface which communicates with an external storage apparatus; a storage unit; an information generator which generates sharing setting information regarding a content stored in the external storage apparatus, in response to a command to establish a sharing setting for the content stored in the external storage apparatus; and a controller which controls the generated sharing setting information to be stored in at least one of the storage unit and the external storage apparatus and controls a sharing setting state to be maintained when the external storage apparatus is disconnected.

The sharing setting information may be in a metadata format.

The sharing setting information may include an identifier for the external storage apparatus and an identifier for the content which is set to be shared.

The sharing setting information may further include time information regarding a sharing setting job, and the controller may manage the sharing setting information using the time information.

The sharing setting information may be generated with reference to a folder and/or a directory which contains the content.

If there is a change in a previously established sharing setting, the controller may update pre-stored sharing setting information according to the change.

According to an aspect of another exemplary embodiment, there is provided an external storage apparatus including: a storage unit which stores sharing setting information regarding a stored content; and an interface which provides the sharing setting information to a host apparatus to maintain a sharing setting state.

The sharing setting information may be in a metadata format.

The sharing setting information may include an identifier for the external storage apparatus and an identifier for the content which is set to be shared.

The sharing setting information may further include time information regarding a sharing setting job, and the interface may provide the time information to the host apparatus such that the host apparatus manage the sharing setting information.

The sharing setting information may be generated with reference to a folder and/or a directory which contains the content.

According to an aspect of still another exemplary embodiment, there is provided a method for maintaining a sharing setting, the method including: recognizing an external storage apparatus, in response to a command to establish a sharing setting for a content stored in the external storage apparatus; generating sharing setting information regarding the content stored in the external storage apparatus; and storing the generated sharing setting information in at least one of a host apparatus and the external storage apparatus, and maintaining a sharing setting state when the external storage apparatus is disconnected.

The sharing setting information may be in a metadata format.

The sharing setting information may include an identifier for the external storage apparatus and an identifier for the content which is set to be shared.

The sharing setting information may further include time information regarding a sharing setting job, and the method may further include managing the sharing setting information using the time information.

The sharing setting information may be generated with reference to a folder and/or a directory which contains the content.

The method may further include, if there is a change in a previously established sharing setting, updating pre-stored sharing setting information according to the change.

Accordingly, the sharing setting state can be maintained even if the external storage apparatus is disconnected.

According to an aspect of yet another exemplary embodiment, there is provided a method of maintaining a sharing setting, the method including: recognizing, by a host apparatus, a connection of an external storage apparatus to the host apparatus; detecting, by the host apparatus, sharing setting information regarding a sharing setting for a content stored in the external storage apparatus, the sharing setting information being detected in a storage of the host apparatus or in the external storage apparatus; and maintaining a sharing setting state corresponding to the sharing setting according to the detected sharing setting information, wherein the sharing setting information is stored in the storage of the host apparatus or in the external storage apparatus prior to the recognized connection of the external storage apparatus to the host apparatus.

### BRIEF DESCRIPTION OF THE DRAWINGS

The above and/or other aspects will be more apparent by describing in detail exemplary embodiments, with reference to the accompanying drawings in which:

FIG. 1 is a block diagram illustrating a host apparatus according to an exemplary embodiment;

FIG. 2 is a block diagram illustrating a host apparatus according to another exemplary embodiment;

FIG. 3 is a block diagram illustrating an external storage apparatus according to an exemplary embodiment;

FIGS. 4A to 4C and FIGS. 5A to 5C are views to explain formats of sharing setting information according to diverse exemplary embodiments; and

FIG. 6 is a flowchart illustrating a method of maintaining a sharing setting according to an exemplary embodiment.

### DETAILED DESCRIPTION OF THE EXEMPLARY EMBODIMENTS

Hereinafter, exemplary embodiments will be described in greater detail with reference to the accompanying drawings.

In the following description, same reference numerals are used for the same elements when they are depicted in different drawings. The matters defined in the description, such as detailed construction and elements, are provided to assist in a comprehensive understanding of the exemplary embodiments. Thus, it is apparent that the exemplary embodiments can be carried out without those specifically defined matters. Also, functions or elements known in the related art are not described in detail since they would obscure the invention with unnecessary detail.

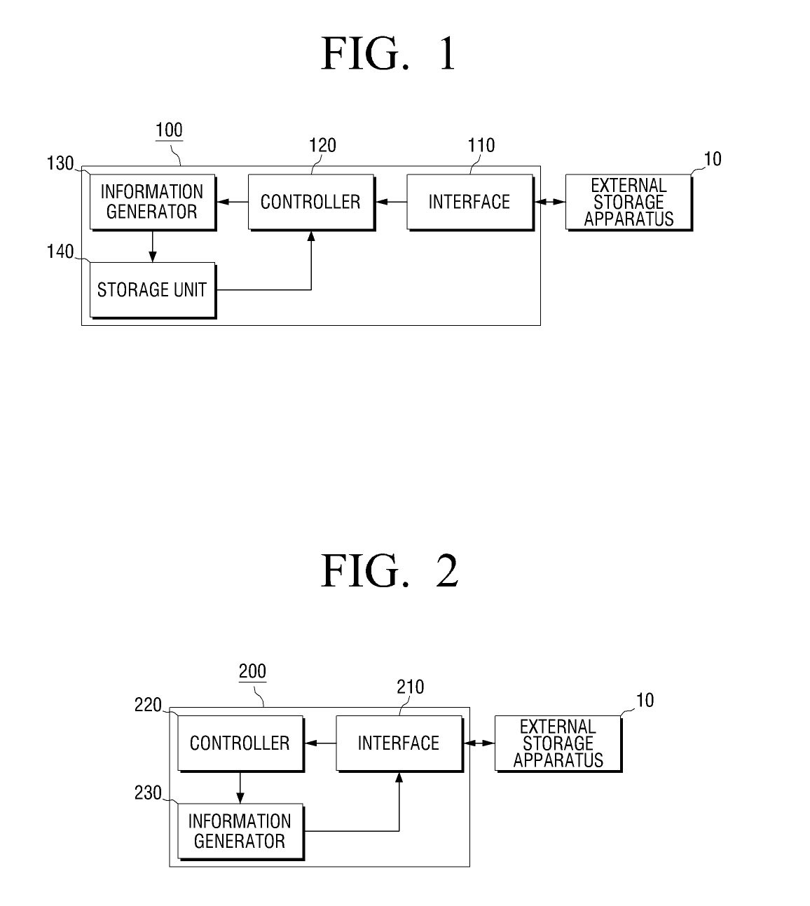

FIG. 1 is a block diagram illustrating a host apparatus 100 according to an exemplary embodiment. Referring to FIG. 1, the host apparatus 100 includes an interface 110, a controller 120, an information generator 130, and a storage unit 140. The host apparatus 100 can be any type of apparatus that can communicate with an external storage apparatus 10.

For example, the host apparatus 100 may be realized as a general host apparatus supporting a network, such as a digital television (DTV) and a personal computer (PC), or may be realized as an image forming apparatus, such as a mobile terminal, which includes a mobile phone, a portable multimedia player (PMP), and an MP3 player, a printer, and a multifunction peripheral (MFP).

A representative example of the external storage apparatus 10 is an apparatus that can communicate with the host apparatus 100 through a USB port, and, for example, may be a USB, a USB Flash, a USB hard disk drive (HDD), and a HDD. However, the external storage apparatus 10 is not limited to these devices and any type of apparatus that can communicate with the host apparatus 100 and have a storage operation can be applied. For example, the external storage apparatus 10 and the host apparatus 100 may communicate via a Bluetooth connection, an infrared connection, a firewire connection, an IEEE 1394 connection, etc. For convenience of explanation, however, the external storage apparatus 10 is described herein as an apparatus that performs USB communication with the host apparatus 100.

The interface 110 performs the USB communication with at least one external storage apparatus 10. The external storage apparatus 10 may be realized as a USB Flash and a USB HDD (hereinafter, referred to as a USB). The interface 110 may include a control interface to perform USB control communication with the at least one external storage apparatus 10, and/or a data interface to perform USB data communication with the at least one external storage apparatus 10. The control interface serves as a part to connect, disconnect, and/or recognize the external storage apparatus 10 and may be realized as a control end point. The data interface serves as a part to transmit data and may be realized as a data end point.

The controller 120 controls an overall operation of the host apparatus 100, and in particular, controls a sharing setting operation regarding contents stored in the external storage apparatus 10. That is, if the external storage apparatus 10 is recognized through the interface 110, the controller 120 controls a sharing setting operation regarding contents stored in the external storage apparatus 10 such that the contents can be shared by other apparatuses connected through a network.

Also, if a sharing setting is established for the contents stored in the external storage apparatus 10 when the external storage apparatus 10 is recognized, the controller may control the information generator 130 to generate sharing setting information for the sharing setting. Furthermore, the controller 120 may control the storage unit 140 to store the sharing setting information generated by the information generator 130 and control the sharing setting state to be maintained even when the external storage apparatus 10 is disconnected. Moreover, if there is a change in an already established sharing setting, the controller 120 may control the information generator 130 to update the sharing setting information according to the change.

The information generator 130 generates information regarding the sharing setting for the contents stored in the external storage apparatus 10 (hereinafter, referred to as the “sharing setting information”). Specifically, if the external storage apparatus 10 is recognized through the interface 110 and a sharing setting for some or all of contents stored in the external storage apparatus 100 is established through an input unit (not shown), the information generator 130 is controlled by the controller 120 to generate the sharing setting information.

The sharing setting may be established for each directory or folder. However, this should not be considered as limiting. For example, in some situation, the sharing setting may be established for each file or content. Hereinafter, in the present description, the sharing setting is established for each directory for convenience of explanation.

The sharing setting information may include an identifier for the external storage apparatus 10 and an identifier for the directory which is set to be shared. The sharing setting information may further include the number of directories which are set to be shared, names of directories, a sharing setting path, and/or a setting time. The sharing setting information may be generated in the format of an extensible markup language (XML) file (or document) using metadata, and a detailed description thereof will be provided later.

The storage unit 140 stores the sharing setting information generated by the information generator 130 under the control of the controller 120. Accordingly, if the external storage apparatus 10 which has been previously recognized is re-recognized, the already established sharing setting is maintained using the stored sharing setting information.

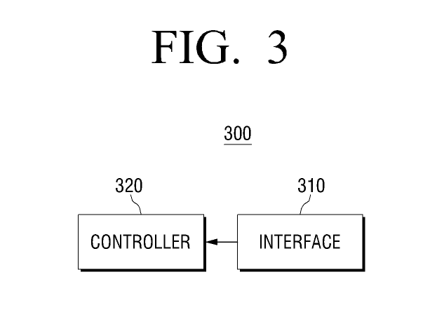

FIG. 2 is a block diagram illustrating a host apparatus 200 according to another exemplary embodiment. Referring to FIG. 2, the host apparatus 200 includes an interface 210, a controller 220, and an information generator 230. With respect to the same elements as those of FIG. 1, a detailed description is omitted herein.

The controller 220 controls sharing setting information generated by the information generator 230 to be stored in the external storage apparatus 10. That is, the host apparatus 100 of FIG. 1 directly stores the sharing setting information in the storage unit 140, whereas the host apparatus 200 of FIG. 2 stores the sharing setting information in the external storage apparatus 10. In this case, the sharing setting information may be stored in a specific area of the external storage apparatus 10 (for example, using a DRAM key for content) so that security can be guaranteed.

In the exemplary embodiment illustrated in FIG. 1, it can be checked whether the external storage apparatus 10 has ever been connected to the host apparatus 100. Accordingly, the sharing setting can be maintained using sharing information set by the corresponding host apparatus 100 or sharing information set by another host apparatus according to the user's setting.

In the exemplary embodiment illustrated in FIG. 2, since the external storage apparatus 10 itself stores the sharing setting information, the sharing setting can be maintained using the sharing setting information even if the external storage apparatus 10 is recognized by a host apparatus (not shown) other than the host apparatus 200 which has generated the sharing setting information. Of course, even in the exemplary embodiment illustrated in FIG. 2, if the sharing setting information is set to include an ID of the host apparatus 200 by which the external storage apparatus 10 has been recognized, the sharing setting may not be maintained at another host apparatus.

Also, it is understood that aspects of the present inventive concept can be applied to a combination of the exemplary embodiment illustrated in FIG. 1 and the exemplary embodiment illustrated in FIG. 2. That is, the sharing setting information may be stored in the host apparatus 100, 200 and the external storage apparatus 10, simultaneously. In this case, a priority may be given to the sharing setting information stored in the host apparatus 100, 200 or that stored in the external storage apparatus 10.

Also, either the host apparatus 100, 200 or the external storage apparatus 10 may be selected by a user as a device to store the sharing setting information. For example, if the host apparatus 100, 200 is selected as the device to store the sharing setting information, the sharing setting information stored in the host apparatus 100, 200 is used even when the external storage apparatus 10 storing sharing setting information is recognized.

Furthermore, in other exemplary embodiments, the user can change a setting such that either the sharing setting information stored in the host apparatus 100, 200 or the sharing setting information stored in the external storage apparatus 10 is used.

The sharing setting information may exist in a root of a first partition of the host apparatus 100, 200 or the external storage apparatus 10. Accordingly, when the external storage apparatus 10 is reconnected after having been disconnected, the already established sharing setting can be maintained.

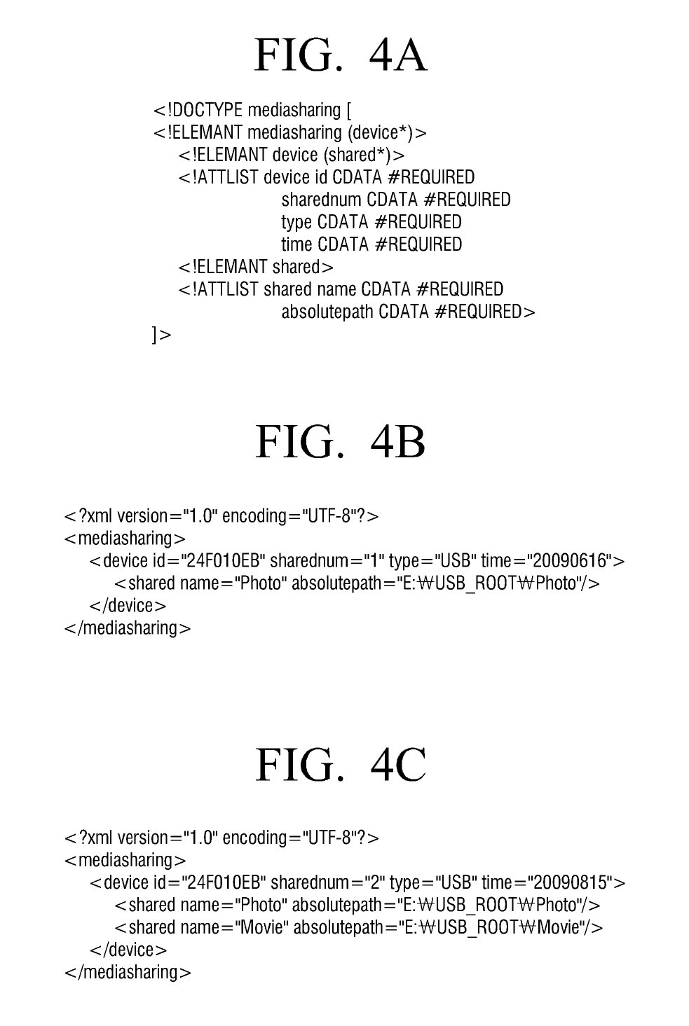

FIG. 3 is a block diagram illustrating an external storage apparatus 300 according to an exemplary embodiment. Referring to FIG. 3, the external storage apparatus 300 includes a storage unit 310 and an interface 320. The external storage apparatus 10 of the exemplary embodiments illustrated in FIGS. 1 and 2 may be implemented as the external storage apparatus 300.

The storage unit 310 stores sharing setting information for contents stored in the external storage apparatus 300. The sharing setting information may be generated by and stored in the host apparatus 100 and 200 while the external storage apparatus 300 is being recognized by the host apparatus 100 and 200.

The interface 320 transmits the sharing setting information to the host apparatus 200 so that the sharing setting state can be maintained even when the external storage apparatus 300 is disconnected.

The sharing setting information may be of a metadata format. Also, the sharing setting information may include an identifier for the external storage apparatus 300 and an identifier for the content which is set to be shared. Furthermore, the sharing setting information may further include time information about a sharing setting operation, and the interface 320 may transmit the time information to the host apparatus 100 and 200 such that the host apparatus 100 and 200 manages the sharing setting information. The sharing setting information may be generated with reference to a folder or a directory containing contents.

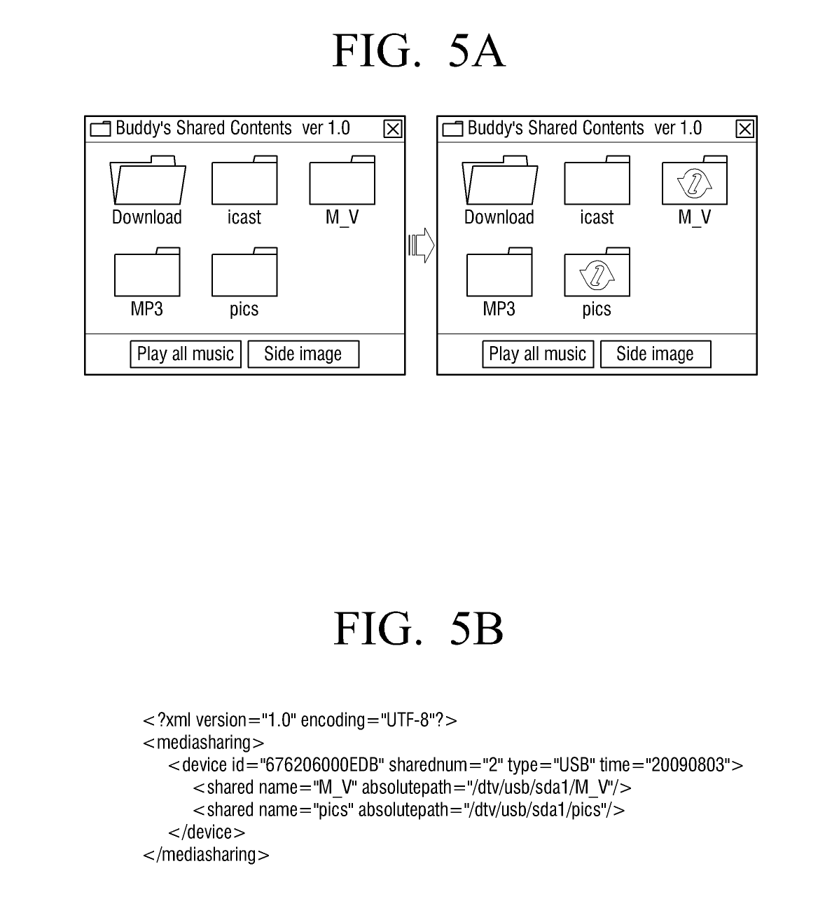

FIGS. 4A to 4C are views illustrating examples of formats of sharing setting information according to an exemplary embodiment.

FIG. 4A illustrates a document type definition (DTD) format as an example of a format of sharing setting information. The DTD is a definition that conforms to the standard generalized markup language (SGML) regulation. The DTD is a standard accompanying a document so as to distinguish paragraphs of the document, identify a subject title, and identify a markup indicating how to process_paragraphs of the document, a subject title, etc.

FIGS. 4B and 4C are views illustrating an XML file regarding the sharing setting information of the DTD format shown in FIG. 4A. In the current exemplary embodiment, an XML is used to generate sharing setting information. The XML refers to a transcription method (language) which is newly defined by a user to describe additional information that is used for representing certain information, and is a multi-purpose markup language that is recommended for creating a specific markup language for another purpose at the world wide web consortium (W3C). The XML may be defined using metadata. Although in this exemplary embodiment, the XML is used to generate the sharing setting information, it is understood that all embodiments are not limited thereto. For example, in other exemplary embodiments, another language such as HTML or XHTML may be used to generate the sharing setting information.

Referring to FIGS. 4B and 4C, the XML file regarding the sharing setting information may include a “mediasharing” tag, a “device” tag, and a “shared” tag. The “mediasharing” tag indicates that the XML file is a sharing setting file. The “device” tag indicates a partition of an external storage apparatus 10 and 300 which is recognized by a host apparatus 100 and 200, and may have attributes such as a device ID (device id), a number of shared directories (sharednum), a device type (type), and an update time (date).

The “device id” indicates an ID of the partition that is owned by the external storage apparatus 10 and 300 and is a unique value of the partition, and thus is a reference value for distinguishing the partition. The “sharednum” indicates the number of directories which are set to be shared at a corresponding device. The “date” indicates the latest date at which the sharing setting information is updated.

For example, if a plurality of external storage apparatus is used, storing information that is not in use may result in a waste of resource. Therefore, if the number of pieces of sharing setting information exceeds a predetermined number of devices, the oldest sharing setting information is canceled (e.g., deleted) with reference to the “date” so that the information can be effectively managed.

The “shared” tag is information regarding a directory of the external storage apparatus 10 and 300 which is set to be shared and includes a directory name (name) and a sharing setting path (absolutepath). The “name” is a shared name of the corresponding directory and can be displayed on an outside device. The “absolutepath” indicates a physical absolute path of the directory which is set to be shared.

It is assumed that the XML file shown in FIG. 4B indicates pre-set sharing setting information. That is, the sharing is set in the directory “Photo” only. If the directory “Movie” is additionally set to be shared, the XML file is updated as shown in FIG. 4C.

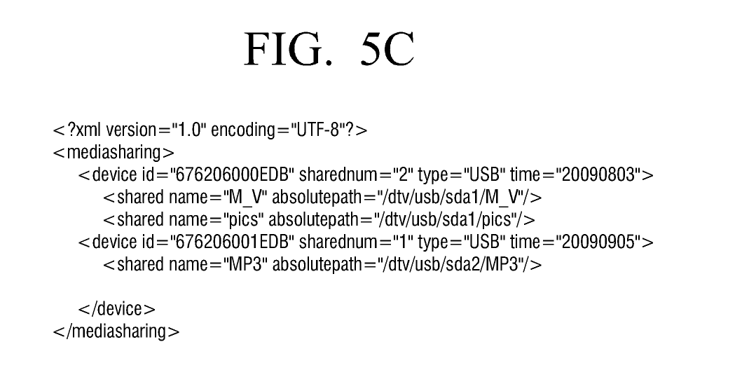

FIGS. 5A to 5C are views illustrating a format of sharing setting information according to another exemplary embodiment. If two directories “M_V directory” and “pics” among directories stored in a USB device recognized by a host apparatus were set to be shared on Aug. 3, 2009 as shown in FIG. 5A, sharing setting information of an XML format is generated as shown in FIG. 5B.

FIG. 5C illustrates a format of an XML file if a single external storage apparatus 10 and 300 has a plurality of partitions. For example, a USB HDD has a plurality of partitions. As shown in FIG. 5C, even if a single external storage apparatus 10 and 300 is recognized, a “device” tag and a “shared tag” depending on the “device” tag are separately generated for each partition.

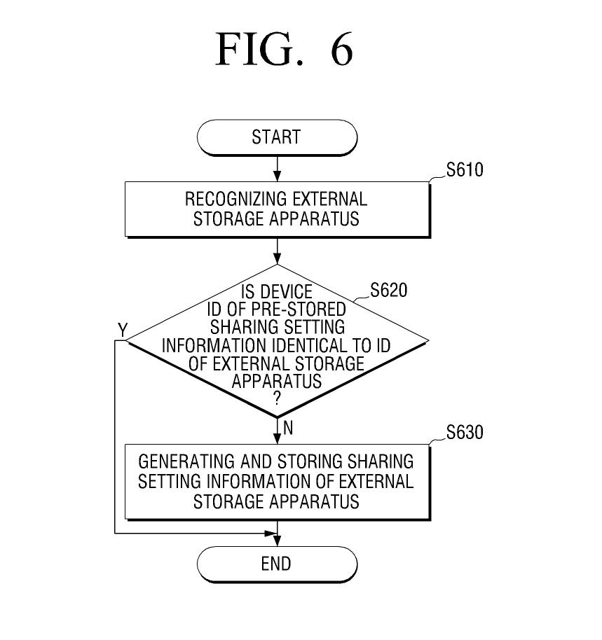

FIG. 6 is a view illustrating a method of maintaining a sharing setting according to an exemplary embodiment. Referring to FIG. 6, if an external storage apparatus 10 and 300 is recognized in operation S610, it is determined whether there is pre-stored sharing setting information.

If it is determined that there is pre-stored sharing setting information, it is determined whether the device ID of the pre-stored sharing setting information is identical to the ID of the recognized external storage apparatus 10 and 300 in operation S620. The sharing setting information is information that is stored in a host apparatus 100 and 200 and/or the external storage apparatus 10 and 300.

If it is determined that there is no pre-stored sharing setting information, sharing setting information regarding the recognized external storage apparatus is generated without requiring an additional operation.

If the device ID of the pre-stored sharing setting information is identical to the ID of the recognized external storage apparatus 10 and 300 (operation S620: Y), a sharing setting for the recognized external storage apparatus 10 and 300 can be maintained using the pre-stored sharing setting information.

If the device ID of the pre-stored sharing setting information is not identical to the ID of the recognized external storage apparatus 10 and 300 (operation S620: N), there is no sharing setting information regarding the recognized external storage apparatus 10 and 300 and thus sharing setting information regarding the recognized external storage apparatus 10 and 300 is generated and stored in operation S630.

If there is a change in an already established original sharing setting, the pre-stored sharing setting information is updated according to the change. Furthermore, the sharing setting may be established for each directory, though it is understood that all embodiments of the present inventive concept are not limited thereto. In some exemplary embodiments, the sharing setting may be established for each content or file.

The generated sharing setting information may include an identifier for the external storage apparatus 10 and 300 and an identifier for the directory which is set to be shared. The sharing setting information may further include the number of directories set to be shared, names of directories, a sharing setting path, and/or a sharing setting time. Also, the sharing setting information may be generated in the format of an XML file (or document) using metadata. This will be described in detail below.

Accordingly, if an external storage apparatus 10 and 300 which has previously been recognized is re-recognized, the already established sharing setting can be maintained using the pre-stored sharing setting information.

If the sharing setting information is stored in the host apparatus 100 and 200, it is checked whether the external storage apparatus 10 and 300 has previously bee, connected to the host apparatus 100 and 200. Accordingly, the sharing setting can be maintained using the sharing information set by the host apparatus 100 and 200 or sharing information set by another host apparatus according to a user's setting.

Also, if the sharing setting information is stored in the external storage apparatus 10 and 300, the sharing setting can be maintained using the sharing setting information even when the external storage apparatus 10 and 300 is recognized by a host apparatus other than the host apparatus 100 and 200 which has generated the sharing setting information. Furthermore, the user may change the setting to use either the sharing setting information stored in the host apparatus 100 and 200 or the sharing setting information stored in the external storage apparatus 10 and 300.

Also, the sharing setting information may exist in the root of the first partition of the host apparatus 100 and 200 or the external storage apparatus 10 and 300. Accordingly, if the external storage apparatus 10 and 300 is reconnected to the host apparatus 100 and 200 after having been disconnected from the host apparatus 100 and 200, the sharing setting can be maintained.

The sharing setting information may be generated in the format of an XML file, and the XML file for the sharing setting information may include a “mediasharing” tag, a “device” tag, and a “shared” tag. The “mediasharing” tag indicates that the XML file is a sharing setting file, and the “device” tag indicates a partition of the external storage apparatus 10 and 300 recognized by the host apparatus 100 and 200 and may include attributes such as a device ID (device id), a number of shared directories (sharednum), a device type, and a update time (date). The “shared” tag indicates information about a directory of the external storage apparatus 10 and 300 which is set to be shared, and includes a directory name (name) and a sharing setting path (absolutepath).

As described above, since the sharing setting for the external storage apparatus 10 and 300 can be maintained, the user is not required to establish a sharing setting every time that the external storage apparatus 10 and 300 is recognized.

While not restricted thereto, aspects of the present inventive concept can also be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Aspects of the present inventive concept may also be realized as a data signal embodied in a carrier wave and comprising a program readable by a computer and transmittable over the Internet. Moreover, while not required in all aspects, one or more units of the host apparatus 100 or 200 can include a processor or microprocessor executing a computer program stored in a computer-readable medium, such as the storage unit 140 or the external storage apparatus 10 or 300.

The foregoing exemplary embodiments and advantages are merely exemplary and are not to be construed as limiting the present invention. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A host apparatus comprising:
an interface which communicates with an external storage apparatus;
a storage unit;
an information generator which generates sharing setting information regarding a sharing setting of a content stored in the external storage apparatus, in response to a command to establish the sharing setting for the content stored in the external storage apparatus; and
a controller which controls the generated sharing setting information to be stored in at least one of the storage unit and the external storage apparatus and controls a sharing setting state corresponding to the sharing setting to be maintained when the external storage apparatus is disconnected.

2. The host apparatus as claimed in claim 1, wherein the sharing setting information is in a metadata format.

3. The host apparatus as claimed in claim 1, wherein the sharing setting information comprises an identifier for the external storage apparatus and an identifier for the content which is set to be shared.

4. The host apparatus as claimed in claim 3, wherein:
the sharing setting information further comprises time information regarding a sharing setting job; and
the controller manages the sharing setting information using the time information.

5. The host apparatus as claimed in claim 1, wherein the information generator generates the sharing setting information with reference to a folder or a directory which contains the content.

6. The host apparatus as claimed in claim 1, wherein, in response to a change to a previously established sharing setting, the controller updates pre-stored sharing setting information corresponding to the previously established sharing setting according to the change.

7. The host apparatus as claimed in claim 1, wherein the controller controls the generated sharing setting information to be stored in a root of a first partition of the storage unit and/or the external storage apparatus.

8. An external storage apparatus comprising:
a storage unit which stores content and sharing setting information regarding a network sharing setting of the stored content; and
an interface which provides the sharing setting information to a host apparatus when reconnected thereto to maintain a sharing setting state after being disconnected and reconnected to the host apparatus.

9. The external storage apparatus as claimed in claim 8, wherein the sharing setting information is in a metadata format.

10. The external storage apparatus as claimed in claim 8, wherein the sharing setting information comprises an identifier for the external storage apparatus and an identifier for the content which is set to be shared.

11. The external storage apparatus as claimed in claim 10, wherein:
the sharing setting information further comprises time information regarding a sharing setting job; and
the interface provides the time information to the host apparatus such that the host apparatus manages the sharing setting information using the provided time information.

12. The external storage apparatus as claimed in claim 8, wherein the sharing setting information is generated with reference to a folder or a directory which contains the content.

13. A method of maintaining a sharing setting, the method comprising:
recognizing, by a host apparatus, an external storage apparatus connected to the host apparatus;
in response to a command to establish a sharing setting for a content stored in the external storage apparatus, generating, by the host apparatus, sharing setting information regarding the sharing setting of the content stored in the external storage apparatus; and
storing the generated sharing setting information in at least one of the host apparatus and the external storage apparatus, and maintaining a sharing setting state corresponding to the sharing setting when the external storage apparatus is disconnected.

14. The method as claimed in claim 13, wherein the sharing setting information is in a metadata format.

15. The method as claimed in claim 13, wherein the sharing setting information comprises an identifier for the external storage apparatus and an identifier for the content which is set to be shared.

16. The method as claimed in claim 15, further comprising managing the sharing setting information using time information regarding a sharing setting job, the sharing setting information further comprising the time information.

17. The method as claimed in claim 13, wherein the generating of the sharing setting information comprises generating the sharing setting information with reference to a folder or a directory which contains the content.

18. The method as claimed in claim 13, further comprising, in response to a change to a previously established sharing setting, updating pre-stored sharing setting information corresponding to the previously established sharing setting according to the change.

19. A computer readable recording medium having recorded thereon a program executable by a computer for performing the method of claim 13.

20. A method of maintaining a sharing setting, the method comprising:
recognizing, by a host apparatus, a connection of an external storage apparatus to the host apparatus;
detecting, by the host apparatus, sharing setting information regarding a sharing setting for a content stored in the external storage apparatus, the sharing setting information being detected in a storage of the host apparatus or in the external storage apparatus; and
maintaining a sharing setting state corresponding to the sharing setting according to the detected sharing setting information,
wherein the sharing setting information is stored in the storage of the host apparatus or in the external storage apparatus prior to the recognized connection of the external storage apparatus to the host apparatus.

21. A computer readable recording medium having recorded thereon a program executable by a computer for performing the method of claim 20.
